(19) United States
(12) Patent Application Publication
(10) Pub. No.: US 2025/0385058 A1
(43) Pub. Date: Dec. 18, 2025

(54) Microswitch Capable of Switching Between Sound State and Silent State

(71) Applicant: DONGGUAN CITY KAIHUA ELECTRONICS CO.LTD, Dongguan, Guangdong (CN)

(72) Inventors: Fuxi Wu, Dongguan (CN); Yun Huang, Dongguan (CN)

(21) Appl. No.: 18/807,134

(22) PCT Filed: Feb. 16, 2023
(86) PCT No.: PCT/CN2023/076386

§ 371 Date: Aug. 16, 2024

(51) Int. Cl. H01H 13/52; H01H 13/38; H01H 13/84

(52) U.S. Cl. CPC H01H 13/52; H01H 13/38; H01H 13/84; H01H 2215/03; H01H 2235/028

(57) ABSTRACT

Provided is a microswitch capable of switching between a sound state and a silent state, comprising a base (1) and a cover (2), a guide core (4) being provided in an accommodating cavity formed by combining the cover (2) and the base (1), and further comprising a turn-on mechanism (5) and a sound state/silent state switching mechanism (6), the turn-on mechanism (5) comprising a first turn-on terminal (51) and a second turn-on terminal (52) separately provided on the base (1), and an elastic assembly (53) provided in the accommodating cavity, the elastic assembly (53) comprising an elastic piece (531) provided on the first turn-on terminal (51) and located at the bottom of the guide core (4), an arched elastic piece (532) upwards supporting the elastic piece (531), and a turn-on contact piece (533) located above the second turn-on terminal (52) and extending towards the side away from the sound state/silent state switching mechanism (6); the sound state/silent state switching mechanism (6) comprising a sound production knock block (61),a toggle-type switching assembly (62), an upper soft portion (63) connected to the toggle-type switching assembly (62) and a lower soft portion (64) connected to the toggle-type switching assembly (62) and located below the upper soft portion (63). The functions of the mechanisms do not interfere with each other, and the turn-on/off function and the function of switching between a sound state and a silent state are achieved with high accuracy.

### TECHNICAL FIELD

The invention relates to the field of microswitches, in particular to a switchable microswitch with sound and silence.

### TECHNICAL BACKGROUND

According to the classification of sound and silence, micro-switch can be divided into sound micro-switch and silent micro-switch. Sound micro-switch can make users feel better, but its sound will make it noisy in some occasions. Silent microswitch will not make sound, which can meet the needs of some users for pressing silence, but the silent microswitch has poor hand feel.

In order to meet different needs, there are microswitches on the market that can switch between sound and silence. However, in this kind of microswitch, the positions of the audible and silent switching mechanisms and the positions of the contact points are located in the same area, and the space design is unreasonable, which will interfere with each other, thus affecting the realization of the on-off function and the audible and silent switching function.

### SUMMARY OF THE INVENTION

In view of the above shortcomings, the purpose of the present invention is to provide a switchable micro switch with sound and silence, in which the functions of various mechanisms are not interfered with each other, and the realization accuracy of the on-off function and the sound and silence switching function is high.

The technical scheme adopted by the invention for achieving the above purpose is as follows:

A microswitch capable of switching sound and silence comprises a base and a cover arranged above the base, wherein the cover and the base are combined to form an accommodating cavity, a guide core is arranged in the accommodating cavity, and an upper opening for the upper end of the guide core to pass through is opened on the cover, Characterized by also comprising a conducting mechanism and a switching sound and silence mechanism, wherein the conducting mechanism comprises a first conducting terminal and a second conducting terminal respectively arranged on the base, and an elastic component arranged in the accommodating cavity, Wherein, the elastic component comprises an elastic sheet which is erected on the first conducting terminal and located below the guide core, an arched elastic sheet which supports the elastic sheet upwards, and a conducting contact sheet which is located above the second conducting terminal and extends to the side far away from the switching sound and silence mechanism; The switching type sound and silence mechanism comprises a sound striking block for the elastic piece to strike, a toggle switching component, an upper soft part connected to the toggle switching component, and a lower soft part connected to the toggle switching component and located below the upper soft part.

As a further improvement of the invention, the first conducting terminal is provided with a first connecting part and a second connecting part located above the base, and the outer side of the first connecting part is provided with a first clamping groove, and the outer side of the second connecting part is provided with a second clamping groove; The elastic sheet is provided with a first opening for the first connecting part to pass through and a second opening for the arched elastic sheet to pass through, the inner wall of the first opening of the elastic sheet is clamped in the first clamping groove, the tail end of the arched elastic sheet is clamped in the second clamping groove, and the head end of the arched elastic sheet supports the elastic sheet upwards.

As a further improvement of the invention, the arched elastic sheet, the conductive contact sheet and the elastic sheet are connected into a whole.

As a further improvement of the invention, the arched elastic sheet is formed by the upward arch of the inner wall of the second opening of the elastic sheet, and the conductive contact sheet is formed by the downward extension of the inner wall of the second opening of the elastic sheet.

As a further improvement of the invention, the head end of the arched elastic sheet is integrally connected with the elastic sheet by two elastic strips, and the end of the conductive contact sheet connected with the elastic sheet is located between the two elastic strips.

As a further improvement of the invention, the conductive contact piece and the elastic piece are connected into a whole, and the head end of the arched elastic piece extends to the lower end of the elastic piece and abuts against the lower end face of the elastic piece.

As a further improvement of the invention, the conductive contact piece is formed by extending downward from the inner wall of the second opening of the elastic piece, two first abutting blocks are formed on the inner wall of the second opening of the elastic piece, the head end of the arched elastic piece is provided with two first abutting strips abutting against the lower ends of the two first abutting blocks, and the end part of the conductive contact piece connected with the elastic piece is located between the two first abutting strips.

As a further improvement of the invention, the head end of the arched elastic sheet extends to the lower end of the elastic sheet and abuts against the lower end surface of the elastic sheet, and the conductive contact sheet is connected with the arched elastic sheet into a whole.

As a further improvement of the invention, two second abutting blocks are formed on the inner wall of the second opening of the elastic sheet, and the head end of the arched elastic sheet is provided with two second abutting strips abutting on the lower ends of the two second abutting blocks; The conductive contact piece is for by that downward extension of the head end of the arched spr piece, and the end part of the conductive contact piece connected with the arched spring piece is position between two second abutting strips.

As a further improvement of the invention, a moving contact is arranged on the lower end face of the conductive contact piece, and an arched contact part is arranged on the upper end face of the base on the second conductive terminal, and the arched contact part is directly below the moving contact.

As a further improvement of the invention, the toggle-type switching assembly comprises a rotary mounting seat rotatably arranged on the upper cover or the base, and a shifting handle connected to the rotary mounting seat and extending to the outer sides of the upper cover and the base, wherein the rotary mounting seat is respectively provided with an upper connecting arm and a lower connecting arm positioned below the upper connecting arm, the upper soft part is arranged at the lower end of the upper connecting arm, and the lower soft part is arranged at the upper end of the lower connecting arm.

As a further improvement of the invention, the upper soft part and the lower soft part are both silica gel.

As a further improvement of the invention, the base is provided with a limiting elastic sheet located at the lower side of the rotating mounting seat, a limiting protrusion is protruded on the side of the limiting elastic sheet close to the rotating mounting seat, and two limiting grooves matched with the limiting protrusion are formed on the lower side of the rotating mounting seat.

As a further improvement of the invention, an installation groove for installing the lower part of the rotary installation seat is formed on the base, and a limiting clamping groove for embedding the limiting elastic sheet is formed on one side of the installation groove, and a central rotating shaft is arranged on the installation groove, and the rotary installation seat is rotatably sleeved on the central rotating shaft.

As a further improvement of the invention, a side limit opening is formed on the sounding percussion block, an upper percussion sounding part is formed at the upper end of the side limit opening, and a lower percussion sounding part is formed at the lower end of the side limit opening; One end of the elastic sheet passes through the side limiting opening, and the upper tapping sound part is above one end of the elastic sheet, and the lower tapping sound part is below one end of the elastic sheet.

As a further improvement of the present invention, the distance between the upper percussion sounding part and the lower percussion sounding part is greater than the distance between the upper soft part and the lower soft part.

As a further improvement of the invention, the sounding percussion block is arranged on the base through a connecting terminal.

The invention has the beneficial effects that:
(1) By separating the contact point of the conducting mechanism from the switching mechanism with sound and silence, that is, separating the two areas, the space design is reasonable and there is no interference between them, which improves the accuracy of the realization of the on-off function and the switching function with sound and silence.
(2) Through the combination of the elastic sheet, the arched elastic sheet and the conductive contact sheet in the elastic assembly, the elastic restoring force of pressing is provided, and at the same time, the conductive contact point is driven to move up and down to realize the functions of making and breaking. During the whole pressing process, all structural actions are smooth and accurate, and the accuracy of making and breaking functions is high.
(3) By adding a toggle-type switching component with a special structural design, and operating the toggle-type switching component, the upper soft part and the lower soft part can be adjusted to switch between being close to the elastic sheet and being away from the elastic sheet, so as to change the knocking object when the elastic sheet rebounds, and when the elastic sheet rebounds, the knocking block can make sound, so as to achieve the purpose of pressing sound; When the elastic sheet rebounds, knocking on the upper soft part and the lower soft part can achieve the mute effect, so as to achieve the purpose of pressing silence, thus realizing the free switching between sound and silence. Therefore, users can freely and flexibly switch between sound and silent state according to their own use needs, and the operation is simple, and the flexibility of the product is high, which meets the use needs of users and brings great convenience to users.

The above is an overview of the technical scheme of the invention, and the invention will be further explained with the attached drawings and specific embodiments.

### BRIEF DESCRIPTION OF DRAWINGS

FIG. 1 is a schematic diagram of the internal structure of the microswitch in the audible state in the first embodiment;

FIG. 2 is a schematic diagram of the external structure of the first embodiment;

FIG. 3 is a schematic structural view of the elastic assembly in the first embodiment;

FIG. 4 is a schematic structural diagram of the toggle switch assembly, the upper soft part, the lower soft part and the limiting elastic sheet in the first embodiment;

FIG. 5 is a schematic structural diagram of the sounding percussion block in the first embodiment;

FIG. 6 is a schematic diagram of the internal structure of the microswitch in the silent state in the first embodiment;

FIG. 7 is a schematic diagram of the upper structure of the elastic assembly in the second embodiment;

FIG. 8 is a schematic diagram of the bottom structure of the elastic component in the second embodiment;

FIG. 9 is a schematic diagram of the upper structure of the elastic component in the third embodiment;

FIG. 10 is a schematic diagram of the bottom structure of the elastic component in the third embodiment.

### EMBODIMENT

In order to further illustrate the technical means and effects adopted by the present invention to achieve the predetermined purpose, the specific embodiments of the present invention will be described in detail with the attached drawings and preferred embodiments.

### Embodiment 1

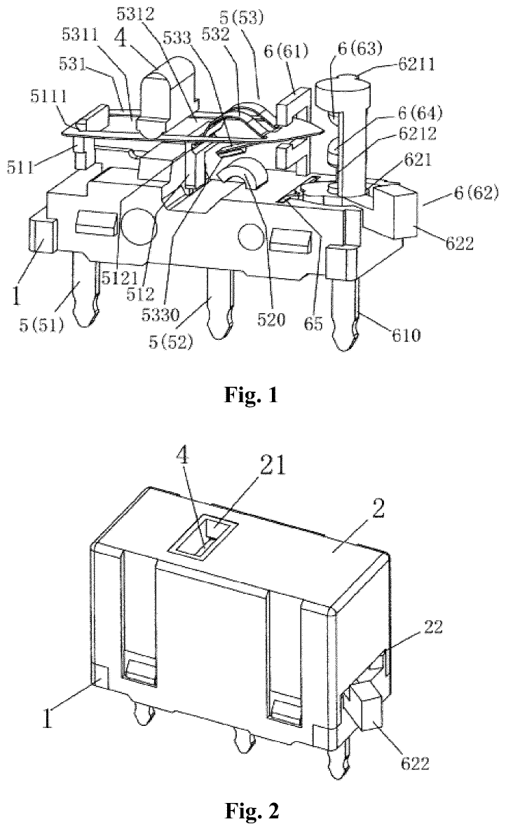

Please refer to FIG. 1 and FIG. 2. This embodiment provides a switchable silent microswitch, which comprises a base 1 and a cover 2 arranged above the base 1. The cover 2 is combined with the base 1 to form an accommodating cavity, a guide core 4 is arranged in the accommodating cavity, and an upper opening 21 for the upper end of the guide core 4 to pass through is opened on the cover 2. As shown in FIG. 2, the guide core 4 can be pressed through the upper opening 21. In specific products, a keycap can be arranged on the guide core 4, and the keycap can pass through the upper opening 21 for pressing.

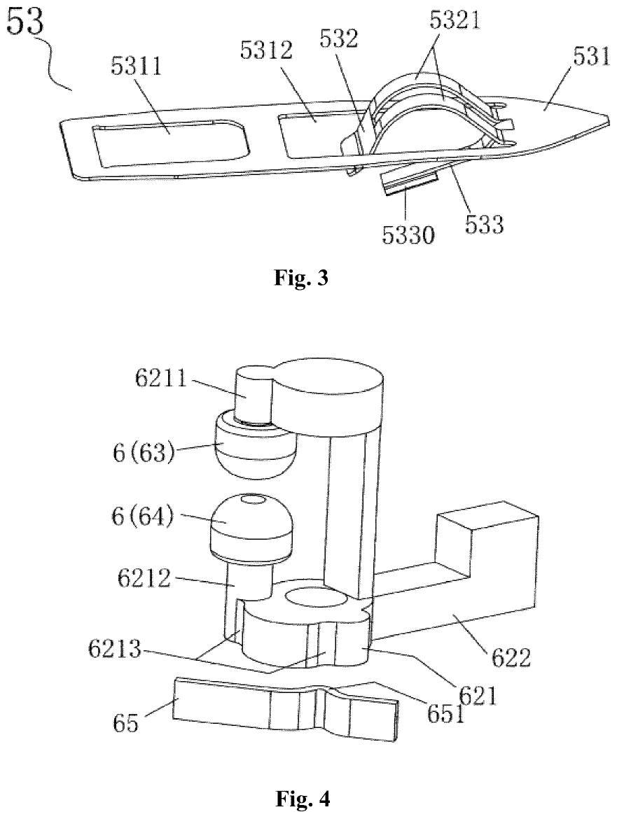

The microswitch of this embodiment further comprises a conducting mechanism 5. Specifically, as shown in FIGS. 1 and 3, the conducting mechanism 5 comprises a first conducting terminal 51 and a second conducting terminal 52 respectively arranged on the base 1, and an elastic component 53 arranged in the accommodating cavity, The elastic assembly 53 includes an elastic piece 531 erected on the first conductive terminal 51 and located below the guide core 4, an arched elastic piece 532 supporting the elastic piece 531 upward, and a conductive contact piece 533 located above the second conductive terminal 52 and extending away from the switching silent mechanism 6 described below. The point on the conductive contact piece 533 that contacts the second conductive terminal 52 is the conductive contact point. Through the combination of the elastic piece 531, the arched elastic piece 532 and the conductive contact piece 533 in the elastic assembly 53, the elastic restoring force is provided, and at the same time, the conductive contact point is driven to move up and down to realize the conduction and disconnection functions. During the whole pressing process, each structure moves smoothly and accurately, and the accuracy of the conduction and disconnection functions is high.

Specifically, when the guide core 4 is not pressed, the whole elastic assembly 53 is in a natural state. At this time, the conductive contact piece 533 is separated from the second conductive terminal 52, and the first conductive terminal 51 and the second conductive terminal 52 are in an off state, so the microswitch is in an off state.

When the guide core 4 is pressed down, the guide core 4 acts on the elastic piece 531 of the elastic assembly 53, which is subjected to the downward force of the guide core 4 and the upward lifting force of the arched elastic piece 532, and the arched elastic piece 532 is subjected to the downward force of the elastic piece 531. Under the mutual force, the elastic piece 531 is elastically deformed downward, and the arched elastic piece 532 is pressed down to be elastically deformed, At the same time, the downward elastic deformation of the elastic piece 531 will drive the conductive contact piece 533 to move down, so that the conductive contact piece 533 contacts the second conductive terminal 52, and then the first conductive terminal 51 and the second conductive terminal 52 are in a conductive state, so that the microswitch is in a conductive state.

However, when the pressing of the guide core 4 is released, the elastic restoring force of the elastic piece 531 and the arched elastic piece 532 is restored upward, and the conductive contact piece 533 is driven to move upward, so that the conductive contact piece 533 is separated from the second conductive terminal 52, and then the first conductive terminal 51 and the second conductive terminal 52 are restored to the off state, so that the microswitch is in the off state.

In this embodiment, as shown in FIG. 1, the first conducting terminal 51 has a first connecting part 511 and a second connecting part 512 located above the base 1, and the outer side of the first connecting part 511 is provided with a first clamping groove 5111, and the outer side of the second connecting part 512 is provided with a second clamping groove 5121; The elastic sheet 531 is provided with a first opening 5311 for the first connecting part 511 to pass through and a second opening 5312 for the arched elastic sheet 532 to pass through. The inner wall of the first opening 5311 of the elastic sheet 531 is clamped in the first clamping groove 5111, the tail end of the arched elastic sheet 532 is clamped in the second clamping groove 5121, and the head end of the arched elastic sheet 532 supports the elastic sheet 531 upward. Therefore, the elastic piece 531 and the arched elastic piece 532 are integrally erected and limited to the first connection part 511 and the second connection part 512 of the first conducting terminal 51, so that the elastic piece 531 and the arched elastic piece 532 can be elastically deformed accurately when the guide core 4 is pressed, and the accuracy of conducting and disconnecting work can be improved.

In this embodiment, as shown in FIG. 3, the arched elastic sheet 532, the conductive contact sheet 533 and the elastic sheet 531 are connected into a whole. Specifically, the arched elastic sheet 532 is formed by the upward arch of the inner wall of the second opening 5312 of the elastic sheet 531, and the conductive contact sheet 533 is formed by the downward extension of the inner wall of the second opening 5312 of the elastic sheet 531. Since the arched elastic sheet 532 is arched upward and the conductive contact sheet 533 extends downward, when the elastic sheet 531 moves up and down due to elastic deformation under pressure, the arched elastic sheet 532 can be elastically deformed above the elastic sheet 531, while the conductive contact sheet 533 moves down below the elastic sheet 531, so that the arched elastic sheet 532 and the conductive contact sheet 533 have no interference with each other and play their respective roles.

In order to further avoid interference, the first end of the arched elastic sheet 532 in this embodiment is integrally connected with the elastic sheet 531 by two elastic strips 5321; The end of the conductive contact piece 533 connected with the elastic piece 531 is located between two elastic strips 5321. Therefore, the connection ends of the elastic piece 532 and the elastic piece 531 are arched, and the connection ends of the conductive contact piece 533 and the elastic piece 531 extend up and down separately, so that the structural design is reasonable, and the interference during the action between them is further avoided, thereby improving the accuracy of each structural action.

In order to better contact the conductive contact piece 533 with the second conductive terminal 52, as shown in FIGS. 1 and 3, in this embodiment, a movable contact 5330 is provided on the lower end face of the conductive contact piece 533, and an arched contact 520 is provided on the upper end face of the base 1 on the second conductive terminal 52, which is located directly below the movable contact 5330. When the conductive contact piece 533 moves down, the movable contact 5330 can better and directly contact with the arched contact part 520, thus improving the accuracy of conduction.

The microswitch of this embodiment also includes a switching sound and silence mechanism 6. Specifically, as shown in FIGS. 1, 4 to 6, the switching sound and silence mechanism 6 includes a sound striking block 61 for the elastic piece 531 to strike, a toggle switch assembly 62, an upper soft part 63 connected to the toggle switch assembly 62, and a lower soft part 64 connected to the toggle switch assembly 62 and located below the upper soft part 63. The toggle switch assembly 62 can drive the upper soft part 63 and the lower soft part 64 to move, When the upper soft part 63 moves above the elastic piece 531 and the lower soft part 64 moves below the elastic piece 531, as shown in FIG. 6, the upper soft part 63 and the lower soft part 64 are directly contacted by the up-and-down movement of the elastic piece 531, and are silenced by the upper soft part 63 and the lower soft part 64, without hitting the sounding percussion block 61, thereby realizing the function of pressing silence; When the upper soft part 63 moves above the elastic piece 531 and the lower soft part 64 moves below the elastic piece 531, as shown in FIG. 1, the elastic piece 531 moves up and down and directly contacts the sounding percussion block 61 to generate sound, but does not contact the upper soft part 63 and the lower soft part 64, thus realizing the function of pressing sound. Thus, the free switching between pressing with sound and pressing without sound is realized.

In this embodiment, the conducting contact point of the conducting mechanism 5 and the switching mechanism 6 are arranged separately, that is, two areas are arranged separately, so that the space design is reasonable and there is no interference between them, and the accuracy of realizing the on-off function and the switching function with sound and silence is improved. In this embodiment, as shown in FIG. 1, FIG. 4 and FIG. 6, the toggle switch assembly 62 includes a rotating mounting seat 621 rotatably arranged on the upper cover 2 or the base 1, and a shifting handle 622 connected to the rotating mounting seat 621 and extending to the outer sides of the upper cover 2 and the base 1. Correspondingly, a side opening 22 for the shifting handle 622 to pass through and shift is opened on the upper cover 2 or the base 1, as shown in FIG. 2. An upper connecting arm 6211 and a lower connecting arm 6212 below the upper connecting arm 6211 are respectively arranged on the rotating mounting base 621. The upper flexible part 63 is arranged at the lower end of the upper connecting arm 6211, and the lower flexible part 64 is arranged at the upper end of the lower connecting arm 6212. Specifically, in this embodiment, the rotary mounting seat 621 is rotatably arranged on the base 1, but it can also be rotatably arranged on the upper cover 2. By pulling the handle 622, the rotary mounting base 621 rotates along with it, thus driving the upper soft part 63 and the lower soft part 64 to rotate, so that the upper soft part 63 and the lower soft part 64 can be switched between being close to the elastic piece 531 and being away from the elastic piece 531, so as to realize the free switching function of pressing with sound and pressing without sound.

In this embodiment, both the upper soft part 63 and the lower soft part 64 have the characteristics of softness, flexibility and elasticity, so that when the elastic sheet 531 acts on the upper soft part 63 and the lower soft part 64, the purpose of silencing is achieved. For the materials of the upper soft part 63 and the lower soft part 64, silica gel can be selected.

In order to generate a touching feeling, in this embodiment, the base 1 is provided with a limiting elastic sheet 65 located at the lower side of the rotary mounting seat 621, a limiting protrusion 651 is protruded on the side of the limiting elastic sheet 65 close to the rotary mounting seat 621, and two limiting grooves 6213 matched with the limiting protrusion 651 are formed on the lower side of the rotary mounting seat 621. When the toggle handle 622 is toggled to drive the rotary mounting base 621 to rotate, the outer side of the rotary mounting base 621 acts on the limiting protrusion 651 of the limiting spring plate 65. Because the limiting protrusion 651 can be elastically deformed, the outer side of the rotary mounting base 621 can interact with the limiting protrusion 651, thus generating a toggle feel. At the same time, after it is dialed in place, it is clamped into the limiting groove 6213 by the limiting protrusion 651, which plays the role of limiting, positioning and preventing shaking, thus improving the accuracy of switching between audible and silent pressing.

In the specific installation, as shown in FIG. 6, in this embodiment, an installation groove 11 is formed on the base 1 for installing the lower part of the rotary mounting seat 621, and a limit clamping groove 12 for embedding the limit elastic piece 65 is formed on one side of the installation groove 11, and a central rotating shaft 13 is arranged on the installation groove 11, and the rotary mounting seat 621 is rotatably sleeved on the central rotating shaft 13. By combining the mounting groove 11, the limiting clamping groove 12 and the central rotating shaft 13, the rotating mounting seat 621 and the limiting elastic sheet 65 can be stably mounted on the base 1, which is beneficial to accurately play their roles.

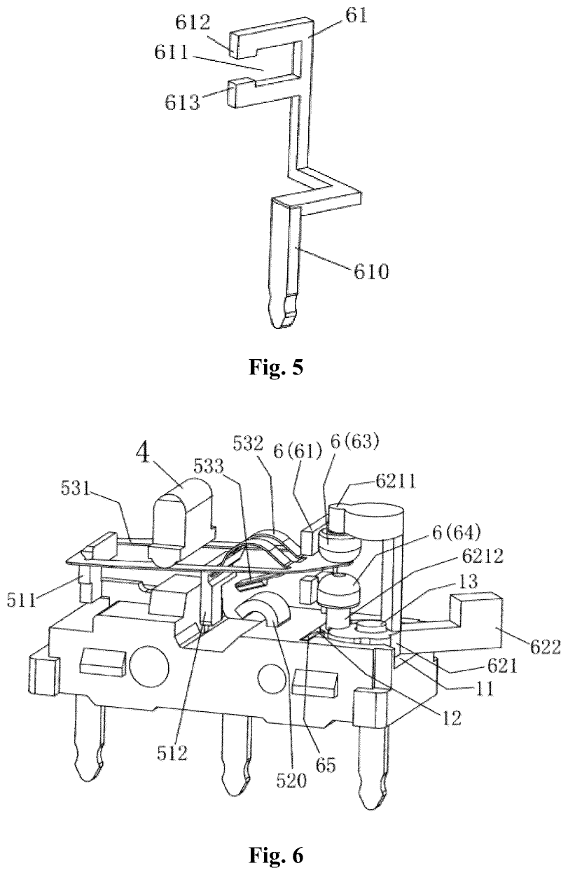

In this embodiment, as shown in FIGS. 1 and 5, a side limit opening 611 is formed in the sounding percussion block 61, an upper percussion sounding part 612 is formed at the upper end of the side limit opening 611, and a lower percussion sounding part 613 is formed at the lower end of the side limit opening 611; One end of the elastic sheet 531 passes through the side limit opening 611, and the upper knocking sound generating part 612 is located above one end of the elastic sheet 531, and the lower knocking sound generating part 613 is located below one end of the elastic sheet 531. Meanwhile, as shown in FIG. 1 and FIG. 5, the sounding percussion block 61 is arranged on the base 1 through a connecting terminal 610.

When the elastic piece 531 moves up and down, it directly hits the upper tapping sound generating part 612 and the lower tapping sound generating part 613 to generate sound.

In order to better realize the switching between audible and silent pressing, as shown in FIGS. 5 and 6, the distance between the upper tapping sounding part 612 and the lower tapping sounding part 613 in this embodiment is greater than the distance between the upper soft part 63 and the lower soft part 64. Therefore, when the upper soft part 63 and the lower soft part 64 rotate to the upper and lower parts of the elastic piece 531, the up-and-down movement of the elastic piece 531 directly acts on the upper soft part 63 and the lower soft part 64 without contacting the upper tapping sound generating part 612 and the lower tapping sound generating part 613, thereby realizing the silent pressing function.

### Embodiment 2

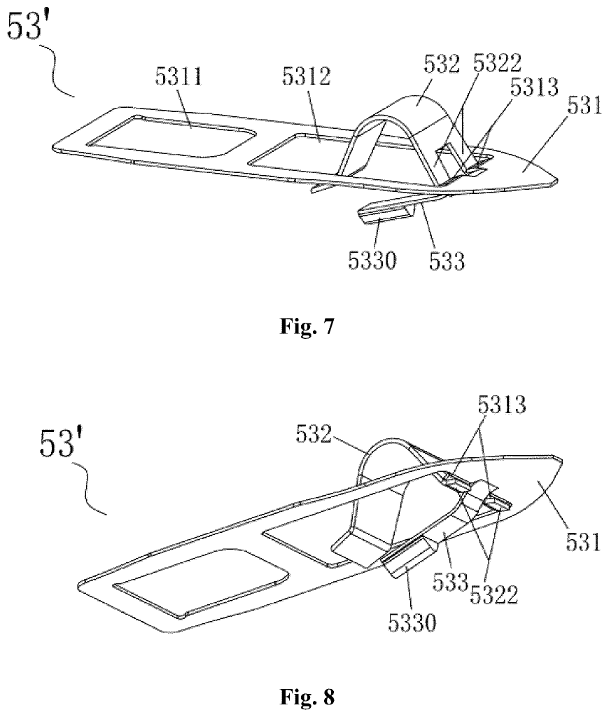

The main difference between this embodiment and the first embodiment is that the structure of the elastic assembly is different. In this embodiment, as shown in FIGS. 7 and 8, the conductive contact piece 533 in the elastic module 53′ is connected with the elastic piece 531 into a whole, and the head end of the arched elastic piece 532 extends to the lower end of the elastic piece 531 and abuts against the lower end surface of the elastic piece 531, so that the arched elastic piece 532 is confined between the second connecting part 512 of the first conductive terminal 51 and the elastic piece 531.

Specifically, the conductive contact piece 533 extends downward from the inner wall of the second opening 5312 of the elastic piece 531, and two first abutting blocks 5313 are formed on the inner wall of the second opening 5312 of the elastic piece 531. The first end of the arched elastic piece 532 has two first abutting strips 5322 abutting against the lower ends of the two first abutting blocks 5313, and the end of the conductive contact piece 533 connected with the elastic piece 531 is located between the two first abutting strips 5322.

Since the arched elastic sheet 532 is arched upward and the conductive contact sheet 533 extends downward, when the elastic sheet 531 moves up and down due to elastic deformation under pressure, the arched elastic sheet 532 can be elastically deformed above the elastic sheet 531, while the conductive contact sheet 533 moves down below the elastic sheet 531, so that the arched elastic sheet 532 and the conductive contact sheet 533 have no interference with each other and play their respective roles. At the same time, the abutting ends of the elastic piece 532 and the elastic piece 531 are arched, and the connecting ends of the conductive contact piece 533 and the elastic piece 531 extend up and down separately, so that the structural design is reasonable, further avoiding the interference when the elastic piece 532 and the elastic piece 531 move together, thereby improving the accuracy of each structural action.

### Embodiment 3

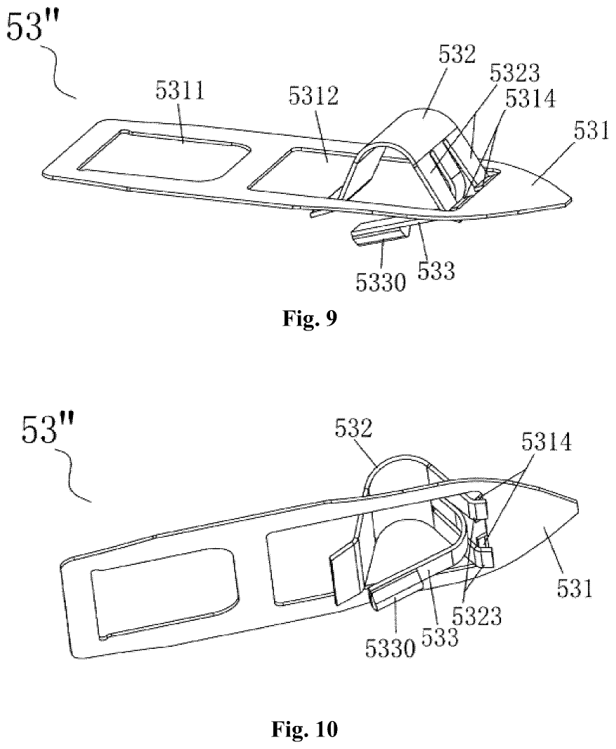

The main difference between this embodiment and Embodiment 1 or Embodiment 2 is that the structure of the elastic assembly is different. In this embodiment, as shown in FIGS. 9 and 10, the first end of the arched elastic piece 532 in the elastic assembly 53 “extends to the lower end of the elastic piece 531 and abuts against the lower end face of the elastic piece 531, and the conductive contact piece 533 is connected with the arched elastic piece 532 as a whole, Thus, the arched elastic piece 532 is limited between the second connecting part 512 of the first conductive terminal 51 and the elastic piece 531.

Specifically, two second abutting blocks 5314 are formed on the inner wall of the second opening 5312 of the elastic sheet 531, and the first end of the arched elastic sheet 532 has two second abutting strips 5323 abutting on the lower ends of the two second abutting blocks 5314; The conductive contact piece 533 is formed by the downward extension of the head end of the arched elastic piece 532, and the connecting end of the conductive contact piece 533 and the arched elastic piece 532 is located between two second abutting strips 5323.

Since the arched elastic sheet 532 is arched upward and the conductive contact sheet 533 extends downward, when the elastic sheet 531 moves up and down due to elastic deformation under pressure, the arched elastic sheet 532 can be elastically deformed above the elastic sheet 531, while the conductive contact sheet 533 moves down below the arched elastic sheet 532, so that the arched elastic sheet 532 and the conductive contact sheet 533 have no interference with each other and play their respective roles. At the same time, the abutting ends of the arched elastic piece 532 and the elastic piece 531, and the connecting ends of the conductive contact piece 533 and the arched elastic piece 532 extend separately, so that the structural design is reasonable, and the interference during the action between them is further avoided, thereby improving the accuracy of each structural action.

The above is only a preferred embodiment of the present invention, and does not limit the technical scope of the present invention, so other structures obtained by adopting the same or similar technical features as the above embodiment of the present invention are within the protection scope of the present invention.

What is claimed is:

1. A microswitch capable of switching sound and silence comprises a base and a cover arranged above the base, wherein the cover and the base are combined to form an accommodating cavity, a guide core is arranged in the accommodating cavity, and an upper opening for the upper end of the guide core to pass through is opened on the cover, and is characterized by further comprising a conducting mechanism and a switching sound and silence mechanism, Wherein, the conduction mechanism comprises a first conduction terminal and a second conduction terminal respectively arranged on the base, and an elastic component arranged in the accommodating cavity, wherein the elastic component comprises an elastic sheet which is erected on the first conduction terminal and positioned below the guide core, an arched elastic sheet which supports the elastic sheet upwards, and a conduction contact sheet which is positioned above the second conduction terminal and extends to one side far away from the switching sound and silence mechanism; The switching type sound and silence mechanism comprises a sound striking block for the elastic piece to strike, a toggle switching component, an upper soft part connected to the toggle switching component, and a lower soft part connected to the toggle switching component and located below the upper soft part.

2. The switchable silent microswitch according to claim 1 is characterized in that the first conducting terminal is provided with a first connecting part and a second connecting part located above the base, and the outer side of the first connecting part is provided with a first clamping groove, and the outer side of the second connecting part is provided with a second clamping groove; The elastic sheet is provided with a first opening for the first connecting part to pass through and a second opening for the arched elastic sheet to pass through, the inner wall of the first opening of the elastic sheet is clamped in the first clamping groove, the tail end of the arched elastic sheet is clamped in the second clamping groove, and the head end of the arched elastic sheet supports the elastic sheet upwards.

3. The switchable silent microswitch according to claim 2 is characterized in that the arched elastic sheet, the conductive contact sheet and the elastic sheet are connected into a whole.

4. The switchable silent microswitch according to claim 3 is characterized in that the arched elastic sheet is formed by the upward arch of the inner wall of the second opening of the elastic sheet, and the conductive contact sheet is formed by the downward extension of the inner wall of the second opening of the elastic sheet.

5. The switchable silent microswitch according to claim 4 is characterized in that the head end of the arched elastic sheet is integrally connected with the elastic sheet by two elastic strips, and the end of the conductive contact sheet connected with the elastic sheet is located between the two elastic strips.

6. The switchable silent microswitch according to claim 2 is characterized in that the conductive contact piece is connected with the elastic piece into a whole, and the head end of the arched elastic piece extends to the lower end of the elastic piece and abuts against the lower end face of the elastic piece.

7. The switchable silent microswitch according to claim 6 is characterized in that the conductive contact piece is formed by extending downward from the inner wall of the second opening of the elastic piece, two first abutting blocks are formed on the inner wall of the second opening of the elastic piece, the head end of the arched elastic piece has two first abutting strips abutting against the lower ends of the two first abutting blocks, and the end of the conductive contact piece connected with the elastic piece is located between the two first abutting strips.

8. The switchable silent microswitch according to claim 2 is characterized in that the head end of the arched elastic sheet extends to the lower end of the elastic sheet and abuts against the lower end face of the elastic sheet, and the conductive contact sheet is connected with the arched elastic sheet into a whole.

9. The switchable silent microswitch according to claim 8 is characterized in that two second abutting blocks are formed on the inner wall of the second opening of the elastic sheet, and the head end of the arched elastic sheet is provided with two second abutting strips abutting on the lower ends of the two second abutting blocks; The conductive contact piece is for by that downward extension of the head end of the arched spr piece, and the end part of the conductive contact piece connected with the arched spring piece is position between two second abutting strips.

10. The switchable silent microswitch according to claim 1 is characterized in that the lower end face of the conductive contact piece is provided with a moving contact, and the second conductive terminal is provided with an arched contact part located at the upper end face of the base, and the arched contact part is directly below the moving contact.

11. The switchable silent microswitch according to claim 1 is characterized in that the toggle switch assembly comprises a rotary mounting seat rotatably arranged on an upper cover or a base, and a shifting handle connected to the rotary mounting seat and extending to the outer sides of the upper cover and the base, wherein the rotary mounting seat is respectively provided with an upper connecting arm and a lower connecting arm below the upper connecting arm, the upper soft part is arranged at the lower end of the upper connecting arm, and the lower soft part is arranged at the lower end.

12. The switchable silent microswitch according to claim 11 is characterized in that the upper soft part and the lower soft part are both made of silica gel.

13. The switchable silent microswitch according to claim 11, the switchable silent microswitch is characterized in that the base is provided with a limiting elastic sheet located at the lower side of the rotating mounting seat, a limiting protrusion is protruded on the side of the limiting elastic sheet close to the rotating mounting seat, and two limiting grooves matched with the limiting protrusion are formed on the lower side of the rotating mounting seat.

14. The switchable silent microswitch according to claim 13 is characterized in that an installation groove for installing the lower part of the rotary mounting seat is formed on the base, and a limit clamping groove for embedding a limit spring piece is formed on one side of the installation groove, and a central rotating shaft is arranged on the installation groove, and the rotary mounting seat is rotatably sleeved on the central rotating shaft.

15. The switchable silent microswitch according to claim 1 is characterized in that a side limit opening is formed on the sounding percussion block, an upper percussion sounding part is formed at the upper end of the side limit opening, and a lower percussion sounding part is formed at the lower end of the side limit opening; One end of the elastic sheet passes through the side limiting opening, and the upper tapping sound part is above one end of the elastic sheet, and the lower tapping sound part is below one end of the elastic sheet.

16. The switchable silent microswitch according to claim 15 is characterized in that the distance between the upper tapping sound generating part and the lower tapping sound generating part is greater than the distance between the upper soft part and the lower soft part.

17. The switchable silent microswitch according to claim 1 is characterized in that the sounding percussion block is arranged on the base through a connecting terminal.
